(19) United States
(12) Patent Application Publication
(10) Pub. No.: US 2026/0324708 A1
(43) Pub. Date: Oct. 22, 2026

(54) DEVICE AND METHOD FOR DE-STEMMING TOBACCO LEAVES

(71) Applicant: PHILIP MORRIS PRODUCTS S.A., Neuchatel (CH)

(72) Inventors: Bruno Rodolfo BINZ, Epalinges (CH); Leonardo Amonte ANACKER, Santa Cruz do Sul (BR); Luciano Luiz WEIGEL, Santa Cruz do Sul (BR); Ricardo TEJADA NUNES, Porto Alegre (BR); Mariana RAMOS DEL CORSO, Sao Paulo (BR); Paulo Rene FALEIRO DOS SANTOS, Santa Cruz do Sul (BR); Roni THEISEN, Santa Cruz do Sul (BR)

(21) Appl. No.: 19/491,023

(22) PCT Filed: Jun. 19, 2024
(86) PCT No.: PCT/EP2024/067145

§ 371 Date: Dec. 8, 2025

(30) Foreign Application Priority Data
Jun. 26, 2023 (EP) 23181380.9

(51) Int. Cl. A24B 5/06; A24B 5/10; B07B 1/24

(52) U.S. Cl. CPC A24B 5/06; A24B 5/10; B07B 1/24

(57) ABSTRACT

A device for de-stemming tobacco leaves, comprises a supporting structure (2) and a cylindrical case (3) rotating about a longitudinal axis (X-X). The cylindrical case (3) comprises a mesh wall (28) and a plurality of elements (18) protruding inside an inner chamber; only one shaft (19) located inside the cylindrical case (3) and comprising a plurality of shaft elements (20) developing from said shaft (19), the shaft (19) being rotatable about a respective main axis and with respect to the cylindrical case (3); at least one motor (13, 24) operatively coupled to the cylindrical case (3) and to the shaft (19), the at least one motor (13, 24) being configured to rotate the cylindrical case (3) and the shaft (19) in opposite directions, in order to separate lamina from stems of the tobacco leaves by making the leaves tumbling inside the cylindrical case (3); the supporting structure having an inlet opening (17) configured to enter tobacco leaves, wherein the inlet opening (17) is located at the proximal end (4) of the cylindrical case (3).

The present disclosure relates to a device for de-stemming tobacco leaves. The present disclosure also relates to a method for de-stemming tobacco leaves. The present device and method fall within the field of industrial tobacco farming for the production of tobacco products, like traditional burning cigarettes, heat-not-burn cigarettes, chewing tobacco, etc.

In the tobacco industry, it is well-known that, in order to process the tobacco into a suitable form for use in the manufacturing of tobacco products, the tobacco leaves have to processed to remove the stems from the rest of the tobacco leaves.

The conventional approach to separate tobacco leaves from stems is using a thresher in which a rotor with metal teeth rotates against a fixed basket. The tobacco leaves pass through the basket and are cut smaller by the metal teeth. The tobacco leaves are collected in large containers located in the bottom half of the thresher. After that, tobacco leaves are transferred to classifiers which use a vertical air stream, then sort the tobacco leaves according to weight (light stem-free lamina is sent onwards while heavy lamina that contains stems is passed through the thresher again) and this is repeated until even the smallest shreds of lamina have been removed from the stem. After threshing, the de-stemmed lamina is re-combined with the lamina tips cut off previously and conveyed for re-drying.

Threshing involves conditioning tobacco with heat and moisture so that it becomes pliable enough to enter the thresher and the stem be removed properly in the thresher. If a correct amount of moisture is not maintained, the stems of the tobacco leaves will not be removed properly. Therefore, industrial threshing requires high moisture content.

Document WO 98/26677A1 discloses an apparatus for threshing tobacco. The apparatus comprises a drum rotating about a substantially horizontal axis in an anti-clockwise direction. A series of lifting lugs are attached to the inside surface of the drum. Co-operating counter-rotating elements form a feeder for the leaves. The counter-rotating elements comprise radially extending arms which run the full length of the drum. The leaves are delivered from between counter-rotating elements into stripping means which has respective arms. The stripping means rotates in the same direction as the drum. The feeder and the stripping means are arranged such that, in use, the tobacco leaves experience shearing forces as they pass from between the counter-rotating elements to the rotating stripping means which forces partially strip the lamina from the stem. The tobacco leaves are fed into one end of the drum, the leaves are threshed throughout the length of the drum and the threshed leaves which have not already passed out of the drum, through screens in its walls, exit the drum at the other end. The length of the elements and the stripping means can be less than the full length of the drum.

It would be desirable to have a device and a method for de-stemming tobacco leaves capable of lowering the energy of the devices required for separation of lamina and stems.

It would be desirable to have a device and a method for de-stemming tobacco leaves capable of reducing the number of devices used for this purpose, the related cost and the overall size of these devices.

It would be also desirable to reduce the carbon footprint of the devices configured for de-stemming tobacco leaves and hence the carbon footprint of the manufacturing lines.

It would be desirable to have a device and a method for de-stemming tobacco leaves which avoid subjecting the leaves to excessive stress that could damage them.

It would be desirable to have a device and a method for de-stemming tobacco leaves capable of performing this operation without breaking the stems.

It would be desirable to have a device and a method for de-stemming tobacco leaves through reduced shearing actions on the leaves.

The present disclosure relates to a device for de-stemming tobacco leaves.

The device for de-stemming tobacco leaves comprises: a supporting structure configured to rest on a base or on ground; a cylindrical case having a longitudinal axis, a proximal end and a distal end opposite the proximal end. The cylindrical case delimits an inner chamber. The cylindrical case is mounted on the supporting structure to rotate about the longitudinal axis. The longitudinal axis may be horizontal or may be inclined with respect to the ground. The cylindrical case comprises at least one mesh wall or a plurality of mesh walls. The cylindrical case may comprise a plurality of elements protruding inside the inner chamber. The supporting structure may have an inlet opening configured to enter tobacco leaves. The inlet opening may be configured to enter the tobacco leaves at the proximal end of the cylindrical case.

The device for de-stemming tobacco leaves comprises only one shaft located inside the cylindrical case and comprising a plurality of shaft elements developing from said shaft. The shaft is rotatable about a respective main axis and with respect to the cylindrical case.

The device for de-stemming tobacco leaves comprises at least one motor operatively coupled to the cylindrical case and to the shaft. The at least one motor is configured to rotate the cylindrical case and the shaft in opposite directions, in order to separate lamina from stems of the tobacco leaves by making the leaves tumbling inside the cylindrical case.

The inventor found that this device for de-stemming tobacco leaves allows to separate stems from lamina by making the leaves tumbling inside the cylindrical case while the leaves are conveyed along said cylindrical case.

The inventor found that this device for de-stemming tobacco leaves allows to separate stems from lamina by eliminating or at least drastically reducing the stripping and shearing action on the leaves and without breaking/threshing the stems. Indeed, the device is designed for gradually lifting or holding the leaves, providing an effective tumble, rather than threshing. The elements and shaft elements are used to convey and making the leaves tumble in the cylindrical case.

The inventor found that this device for de-stemming tobacco leaves allows reduce time and energy consumption with respect to traditional threshers at least because stripping and shearing performed by said traditional threshers require greater forces to be exerted on the leaves and thus higher power supply.

The inventor found that this device for de-stemming tobacco leaves allows to separate stems from lamina through this single device, which is simpler and cheaper than the threshers of the prior art, and through a one-unit rotative processing step.

Thus the inventor found that this device for de-stemming tobacco leaves allows to reduce the carbon footprint related to de-stemming of tobacco leaves and hence the carbon footprint of the manufacturing lines.

Thus the inventor found that this device for de-stemming tobacco leaves allow also to better control de-stemming, synergizing with the industrial curing operations and provide a product suitable for usage at tobacco manufacturing affiliates.

Indeed, the adoption of this device allows also to combine curing and destemming operations at same premises. This device allows to de-stem tobacco leaves in industries that can be installed close to tobacco production and curing points.

In some embodiments, the main axis of the shaft and the longitudinal axis of the cylindrical case overlap or the shaft is coaxial to the cylindrical case. In some other embodiments, the main axis of the shaft and the longitudinal axis of the cylindrical case are parallel and close to each other.

The inventor found that the central position of the shaft with respect to the cylindrical case allows to move, raise, tumble and shuffle the tobacco leaves while limiting the stripping and shearing action on the leaves.

In some embodiments, the cylindrical case rotates clockwise and the shaft rotates counter-clockwise. In some other embodiments, the cylindrical case rotates counter-clockwise and the shaft rotates clockwise.

The plurality of shaft elements are located along at least part of the shaft. The plurality of shaft elements may be located all along the shaft.

In some embodiments, the shaft extends only partially along the cylindrical case starting from the proximal end of the cylindrical case. The shaft may have a first end located at or close to the proximal end of the cylindrical case. The shaft may have a second end located in the inner chamber. In some embodiments, a ratio of an axial length of the shaft to an overall axial length of the cylindrical case is between ¼ and ½, optionally of ⅓.

The cylindrical case may comprise a first part close to the proximal end and the plurality of elements is located only in said first part of the cylindrical case. Said first part of the cylindrical case close to the proximal end may have an axial length equal or close to an axial length of the shaft. A ratio of an axial length of said first part to an overall axial length of the cylindrical case may be between ¼ and ½, optionally of ⅓. Said first part of the cylindrical case close to the proximal end may be made at least partially of a solid wall or comprises a solid cover preventing tobacco leaves from passing through. A remaining second part of the cylindrical case, extending from the first part to the distal end, is made of the at least one mesh wall or comprises the at least one mesh wall.

The inventor found that the leaves are shuffled and the mass of leaves is disaggregated in the first part and are brought against the walls of the cylindrical case by the elements and the shaft elements, while in the subsequent remaining second part of the cylindrical case the leaves are raised by the walls and fall to the bottom of the cylindrical case. In the remaining second part, the rotary movement of the cylindrical case keeps on tumbling the leaves and this tumbling causes the stems to separate from lamina and the lamina to break in small pieces.

In some embodiments, different mesh walls have different features, like different structures, different shapes and/or sizes of the apertures of the mesh, different void to solid ratios. The apertures of the mesh may be square.

The at least one mesh may have apertures having a size ranging between 10 mm and 60 mm. The size may be a length of a side of the square aperture. A void to solid ratio of the at least one mesh wall may decrease moving from the proximal end towards the distal end of the cylindrical case.

The inventor found that the apertures of the mesh or meshes allow pieces of lamina to pass through and leave the cylindrical case while the stems move towards the distal end of the cylindrical case. The lamina pieces are collected under the cylindrical case. If the mesh or meshes has/have different features, pieces of lamina having different sizes may thus leave the cylindrical case in different axial portion of said cylindrical case. The mesh size and type may be adapted to the incoming product that can be more or less fragile depending on stalk position.

In some embodiments, the cylindrical case is elongated. A ratio of an inner diameter of the cylindrical case to an overall axial length of the cylindrical case may be between ⅓ to ⅔, optionally between ⅓ to ½.

The inventor found that the elongated cylindrical case allows a gradual and prolonged over time de-stemming of the leaves and thus the leaves are not subjected to abrupt stripping and shearing and the de-stemming operation is complete and accurate and obtained in the single device.

The elements may be fixed to the cylindrical case or may be integral to the cylindrical case or may be stationary with respect to the cylindrical case. The elements may be radial with respect to the longitudinal axis of the cylindrical case.

The elements may be rod shaped, optionally the elements are straight rods. The elements may be flat rods or rods having a circular cross section.

In some embodiments, the elements are placed in a plurality of series along lines parallel to the longitudinal axis of the cylindrical case. The series may be circumferentially equally spaced from each other. The elements of one of the series may be axially offset with respect to the elements of an adjacent series. Optionally, a ratio of a length of the elements to an inner radius of the cylindrical case is between ⅛ and ¼, optionally of ⅓.

The shaft elements may be fixed to the shaft or may be integral to the shaft or may be stationary with respect to the shaft. The shaft elements may protrude radially from the shaft.

The shaft elements may be rod shaped, optionally the shaft elements are straight rods. The shaft elements may be flat rods or rods having a circular cross section. Terminal free ends of the shaft elements may be close to the cylindrical case. A gap between the terminal free ends of the shaft elements and the cylindrical case may be between 10 mm and 450 mm. A ratio of a length of the shaft elements to an inner radius of the cylindrical case may be between 0.8 and 0.99, optionally of 0.9.

In some embodiments, the shaft elements are axially offset one relative to the other along the shaft. Optionally, each axial portion of the shaft comprises a single shaft element. According to some embodiments, the shaft elements are placed according to a helical path along the shaft.

In some embodiments, when the cylindrical case and the shaft rotate in opposite directions, terminal free ends of the shaft elements may travel between terminal free ends of adjacent elements. Optionally, terminal free ends of the shaft elements are axially spaced from terminal free ends of adjacent elements of a distance greater than 150 mm. Optionally, said distance is between 0 mm and 200 mm. When the cylindrical case and the shaft rotate in opposite directions, terminal free ends of the shaft elements and terminal free ends of the elements may overlap for a radial distance. Optionally, a ratio of said radial distance to an inner radius of the cylindrical case is between 0.05 and 0.2, optionally of 0.1.

The inventor found that these shapes, sizes and positions of the elements and of the shaft elements promote shuffle, tumble and fall of the leaves and disaggregation of the mass of leaves while limiting stripping and shearing of the leaves.

In some embodiments, the cylindrical case comprises a frame and a plurality of walls mounted on the frame and delimiting the inner chamber. Optionally, the walls are mounted on the frame so that said walls can be removed from the frame and replaced.

The inventor found that replacing of the walls allows to adapt the same device according to properties and/or volume of the tobacco leaves to be processed.

In some embodiments, the frame comprises annular elements coaxial to the longitudinal axis and longitudinal elements connecting the annular elements to each other. The walls are connected to said annular elements and/or longitudinal elements.

The inventor found that this structure is light and cheap.

In some embodiments, the walls comprises or are defined by the at least one mesh wall or the plurality of mesh walls. The walls may comprise at least one solid wall, optionally a plurality of solid walls, which prevent/s tobacco leaves from passing through.

In some embodiments, the walls have an arched shape. Optionally the walls have a cylindrical shape or a semi-cylindrical shape. A plurality of walls having the arched shape, once mounted on the frame, may make a cylindrical portion of the cylindrical case. In some embodiments, the cylindrical case comprises a plurality of cylindrical portions positioned one after the other along the longitudinal axis.

In some embodiments, the cylindrical case comprises a central shaft spanning along the longitudinal axis and fixed with respect to the frame. The central shaft may have a first extremity located at the distal end of the cylindrical case and a second extremity positioned in the inner chamber. The first extremity of the central shaft may be rotatably supported by the supporting structure. The second extremity of the central shaft may be pivotally coupled to the second end of the shaft, so that the central shaft and the shaft may rotate in the opposite directions. The second extremity of the central shaft may supported by the frame, optionally through radial struts. The first end of the shaft may be rotatably supported by the supporting structure and/or by a sleeve connected to the cylindrical case through radial struts.

The inventor found that this structure, in addition to being light and cheap, is also stiff enough to adequately carry out its task.

In some embodiments, the device comprises at least one conveyor located under the cylindrical case to receive lamina separated from stems and passed through the at least one mesh wall or the plurality of mesh walls. The at least one conveyor may extend along a conveying direction parallel to the longitudinal axis of the cylindrical case or transversally to the longitudinal axis of the cylindrical case. The at least one conveyor may comprise a plurality of conveyors locates at different locations under the cylindrical case. The at least one conveyor may comprise a transport belt and an upper branch of the transport belt faces the cylindrical case.

In some embodiments, the at least one conveyor comprises at least a first conveyor configured to convey away lamina passing through the mesh wall or mesh walls and falling onto said first conveyor and a second conveyor configured to convey away stems passing through the mesh wall or mesh walls or through a distal aperture on the distal end of the cylindrical case and falling onto said second conveyor.

The inventor found that the conveyor or conveyors allows to automatically convey away lamina and stems already separated for further processing.

The device may also comprise a coverage surrounding at least in part the cylindrical case. The coverage may be fixed with respect to the supporting structure.

The inventor found that the coverage aims to avoid tobacco losses and to guide the tobacco passing through the mesh or meshes to the bottom of the cylindrical case.

In some embodiments, the device comprises rollers rotatably mounted on the supporting structure and the cylindrical case is supported on said rollers. The cylindrical case may comprise annular tracks coaxial to the longitudinal axis and engaging a peripheral surface of the rollers. The annular tracks may be part of the frame or of the walls.

The inventor found that this is a simple and reliable structure to support and rotate the cylindrical case.

In some embodiments, the at least one motor is mounted on the supporting structure.

In some embodiments, the at least one motor comprises a first motor operatively coupled to the cylindrical case and a second motor operatively coupled to the shaft.

In some embodiments, the device comprises a cap mounted on the supporting structure and fixed with respect to the supporting structure. The cap closes the proximal end of the cylindrical case and the inlet opening may be fashioned in the cap.

In some embodiments, the cylindrical case is mounted on the supporting structure such that the longitudinal axis is inclined downwards from the proximal end towards the distal end of the cylindrical case of an inclination angle. Optionally, the inclination angle is adjustable. Optionally, the inclination angle is between 0° and 10°. The inclination angle may be adjusted for product residence time inside the cylindrical case and also may vary in function of load and tobacco characteristics.

The inventor found that the inclination promote the flow of tobacco towards the distal end of the cylindrical case and said inclination angle may be adjusted according to the volume to be processed and/or other properties of the tobacco leaves.

The present disclosure also relates to a method for de-stemming tobacco leaves carried out through a device for de-stemming tobacco leaves comprising: a supporting structure configured to rest on a base or on ground; a cylindrical case having a longitudinal axis, a proximal end and a distal end opposite the proximal end. The cylindrical case delimits an inner chamber. The cylindrical case is mounted on the supporting structure to rotate about the longitudinal axis. The longitudinal axis may be horizontal or may be inclined with respect to the ground. The cylindrical case comprises at least one mesh wall or a plurality of mesh walls. The cylindrical case may comprise a plurality of elements protruding inside the inner chamber. The supporting structure may have an inlet opening configured to enter tobacco leaves at the proximal end of the cylindrical case. The device for de-stemming tobacco leaves comprises only one shaft located inside the cylindrical case and comprising a plurality of shaft elements developing from the shaft. The shaft is rotatable about a respective main axis and with respect to the cylindrical case. The device for de-stemming tobacco leaves comprises at least one motor operatively coupled to the cylindrical case and to the shaft. The at least one motor is configured to rotate the cylindrical case and the shaft in opposite directions, in order to separate lamina from stems of the tobacco leaves by making the leaves tumbling inside the cylindrical case.

The device for de-stemming tobacco leaves employed to carry out the method for de-stemming tobacco leaves may comprise one or more of the features disclosed above.

The method may comprise: introducing tobacco leaves in the cylindrical case through the inlet opening; activating the at least one motor to rotate the cylindrical case and the shaft in opposite directions so that lamina of the tobacco leaves are separated from stems of said tobacco leaves, the lamina and stems being sieved through the mesh wall or mesh walls.

The method may comprise: introducing a mass of tobacco leaves in the inner chamber of the cylindrical case; disaggregating the mass of tobacco leaves through the plurality of elements protruding inside the inner chamber from the cylindrical case and the plurality of shaft elements developing from the only one shaft located inside the cylindrical case and by rotating the cylindrical case and said shaft in opposite directions.

The method may comprise: separating stems from lamina of the tobacco leaves through shuffling the tobacco leaves in the inner chamber by raising the tobacco leaves on walls of the cylindrical case and making the tobacco leaves fall, wherein raising is performed through the rotation of the cylindrical case.

The method may comprise: sieving parts of lamina of the tobacco leaves and/or stems through the at least one mesh wall of the cylindrical case.

In some embodiments, the lamina pass through the mesh wall or mesh walls and the stems are moved towards the distal end of the cylindrical case. Optionally, the stems exit through a distal aperture on a distal end of the cylindrical case.

In some embodiments, lamina passing through the mesh wall or mesh walls fall onto at least one first conveyor and are conveyed away.

In some embodiments, stems fall onto a second conveyor and are conveyed away. The second conveyor may be placed downstream of the at least one first conveyor with respect to a movement of the along the cylindrical case.

In some embodiments, the tobacco leaves, when introduced in the cylindrical case, are dry. Optionally, a moisture content of the tobacco leaves, when introduced in the cylindrical case, is between 5% and 25%, optionally below 15%, optionally below 10%.

The residence time, dimensions, device inclination, configurations of elements and shaft elements may be adjusted according to a volume and properties of tobacco leaves to be processed.

The present disclosure also relates to a tobacco production line comprising a device for de-stemming tobacco leaves according to the above disclosure and/or employing a method for de-stemming tobacco leaves according to the above disclosure.

The tobacco production line may comprise a pneumatic separator and/or a sieve and/or a drier and/or a packing line connected in line downstream of the device for de-stemming tobacco leaves.

As used in the present description, the term “mesh” referred to the wall or walls means a structure having a netlike or weblike pattern with evenly spaced holes and working as a sieve to allow passage of small parts and prevent passage of big parts.

As used in the present description, the terms “upstream” and “downstream” are used to describe the relative positions of components, or portions of components, of the apparatus in relation to the direction in which a material or materials passes through the apparatus along a given path.

The invention is defined in the claims. However, below there is provided a non-exhaustive list of non-limiting examples. Any one or more of the features of these examples may be combined with any one or more features of another example, embodiment, or aspect described herein.

EX1. A device for de-stemming tobacco leaves, comprising:
a supporting structure configured to rest on a base or on ground;
a cylindrical case having a longitudinal axis, a proximal end and a distal end opposite the proximal end; the cylindrical case delimiting an inner chamber; the cylindrical case being mounted on the supporting structure to rotate about the longitudinal axis; the longitudinal axis being horizontal or being inclined with respect to the ground; the cylindrical case comprising at least one mesh wall, optionally a plurality of mesh walls; the cylindrical case comprising a plurality of elements protruding inside the inner chamber;
only one shaft located inside the cylindrical case and comprising a plurality of shaft elements developing from said shaft, the shaft being rotatable about a respective main axis and with respect to the cylindrical case;
at least one motor operatively coupled to the cylindrical case and to the shaft, the at least one motor being configured to rotate the cylindrical case and the shaft in opposite directions, in order to separate lamina from stems of the tobacco leaves by making the leaves tumbling inside the cylindrical case;
optionally, the supporting structure having an inlet opening configured to enter tobacco leaves, optionally the inlet opening being located at the proximal end of the cylindrical case.

EX2. The device according to EX1, wherein the main axis of the shaft and the longitudinal axis of the cylindrical case are parallel and close to each other or wherein the main axis of the shaft and the longitudinal axis of the cylindrical case overlap or the shaft is coaxial to the cylindrical case.

EX3. The device according to EX1 or EX2, wherein the cylindrical case rotates clockwise and the shaft rotates counter-clockwise or the cylindrical case rotates counter-clockwise and the shaft rotates clockwise.

EX4. The device according to any of EX1 to EX3, wherein the plurality of shaft elements is located along at least part of the shaft, optionally all along the shaft.

EX5. The device according to any of EX1 to EX4, wherein the shaft extends only partially along the cylindrical case starting from the proximal end of the cylindrical case; optionally wherein the shaft has a first end located at or close to the proximal end of the cylindrical case; optionally the shaft has a second end located in the inner chamber.

EX6. The device according any of EX1 to EX5, wherein a ratio of an axial length of the shaft to an overall axial length of the cylindrical case is between ¼ and ½, optionally of ⅓.

EX7. The device according to any of EX1 to EX6, wherein the shaft extends only in a first part of the cylindrical case close to the proximal end.

EX8. The device according to any of EX1 to EX7, wherein the cylindrical case comprises a first part close to the proximal end and the plurality of elements is located only in said first part of the cylindrical case.

EX9. The device according to EX7 or EX8, wherein said first part of the cylindrical case close to the proximal end has an axial length equal or close to an axial length of the shaft.

EX10. The device according to any of EX7 to EX9, wherein said first part of the cylindrical case close to the proximal end is made at least partially of a solid wall or comprises a solid cover preventing tobacco leaves from passing through.

EX11. The device according to any of EX7 to EX10, wherein a ratio of an axial length of said first part to an overall axial length of the cylindrical case is between ¼ and ½, optionally of ⅓.

EX12. The device according to any of EX7 to EX11, wherein a remaining second part of the cylindrical case, extending from the first part to the distal end, is made of the at least one mesh wall or comprises the at least one mesh wall.

EX13. The device according to any of EX1 to EX12, wherein different mesh walls have different features, like different structures, different shapes and/or sizes of the apertures of the mesh, different void to solid ratios; optionally the at least one mesh has apertures having a size ranging between 10 mm and 60 mm.

EX14. The device according to EX13, wherein the apertures of the mesh are square and the size is a length of a side of the square aperture.

EX15. The device according to any of EX1 to EX14, wherein a void to solid ratio of the at least one mesh wall decreases moving from the proximal end towards the distal end of the cylindrical case.

EX16. The device according to any of EX1 to EX15, wherein the cylindrical case is elongated, optionally wherein a ratio of an inner diameter of the cylindrical case to an overall axial length of the cylindrical case is between ⅓ and ⅔, optionally between ⅓ and ½.

EX17. The device according to any of EX1 to EX16, wherein the elements are fixed to the cylindrical case or are integral to the cylindrical case or are stationary with respect to the cylindrical case.

EX18. The device according to any of EX1 to EX17, wherein the elements are radial with respect to the longitudinal axis of the cylindrical case.

EX19. The device according to any of EX1 to EX18, wherein the elements are rod shaped, optionally straight rods, optionally flat rods, optionally rods having a circular cross section.

EX20. The device according to any of EX1 to EX19, wherein the elements are placed in a plurality of series along lines parallel to the longitudinal axis of the cylindrical case.

EX21. The device according to EX20, wherein the elements of one of the series is axially offset with respect to the elements of an adjacent series.

EX22. The device according to EX20 or EX21, wherein the series are circumferentially equally spaced from each other.

EX23. The device according to any of EX1 to EX22, wherein a ratio of a length of the elements to an inner radius of the cylindrical case is between ⅛ and ¼, optionally of ⅙.

EX24. The device according to any of EX1 to EX23, wherein the shaft elements are fixed to the shaft or are integral to the shaft or are stationary with respect to the shaft.

EX25. The device according to any of EX1 to EX24, wherein the shaft elements protrude radially from the shaft.

EX26. The device according to any of EX1 to EX25, wherein the shaft elements are rod shaped, optionally straight rods, optionally flat rods, optionally rods having a circular cross section.

EX27. The device according to any of EX1 to EX26, wherein terminal free ends of the shaft elements are close to the cylindrical case.

EX28. The device according to EX27, wherein a gap between the terminal free ends of the shaft elements and the cylindrical case is between 10 mm and 450 mm.

EX29. The device according to any of EX1 to EX28, wherein a ratio of a length of the shaft elements to an inner radius of the cylindrical case is between 0.8 and 0.99, optionally of 0.9.

EX30. The device according to any of EX1 to EX29, wherein the shaft elements are axially offset one relative to the other along the shaft; wherein optionally each axial portion of the shaft comprises a single shaft element; wherein optionally the shaft elements are placed according to a helical path along the shaft.

EX31. The device according to any of EX1 to EX30, wherein, when the cylindrical case and the shaft rotate in opposite directions, terminal free ends of the shaft elements travel between terminal free ends of adjacent elements.

EX32. The device according to any of EX1 to EX31, wherein terminal free ends of the shaft elements are axially spaced from terminal free ends of adjacent elements of a distance greater than 150 mm, optionally between 0 mm and 200 mm.

EX33. The device according to any of EX1 to EX32, wherein, when the cylindrical case and the shaft rotate in opposite directions, terminal free ends of the shaft elements and terminal free ends of the elements overlaps for a radial distance and a ratio of said radial distance to an inner radius of the cylindrical case is between 0.05 and 0.2, optionally of 0.1.

EX34. The device according to any of EX1 to EX33, wherein the cylindrical case comprises a frame and a plurality of walls mounted on the frame and delimiting the inner chamber.

EX35. The device according to EX34, wherein the walls are mounted on the frame so that said walls can be removed from the frame and replaced.

EX36. The device according to EX34 or EX35, wherein the frame comprises annular elements coaxial to the longitudinal axis and longitudinal elements connecting the annular elements to each other, wherein the walls are connected to said annular elements and/or longitudinal elements.

EX37. The device according to any of EX34 to EX36, wherein the walls comprises or are defined by the at least one mesh wall or the plurality of mesh walls.

EX38. The device according to any of EX34 to EX37, wherein the walls comprises at least one solid wall, optionally a plurality of solid walls, which prevent/s tobacco leaves from passing through.

EX39. The device according to any of EX34 to EX38, wherein the walls have an arched shape, optionally a cylindrical shape or a semi-cylindrical shape.

EX40. The device according to EX39, wherein a plurality of walls having the arched shape, once mounted on the frame, make a cylindrical portion of the cylindrical case.

EX41. The device according to EX40, wherein the cylindrical case comprises a plurality of cylindrical portions positioned one after the other along the longitudinal axis.

EX42. The device according to any of EX34 to EX41, wherein the cylindrical case comprises a central shaft spanning along the longitudinal axis and fixed with respect to the frame, the central shaft having a first extremity located at the distal end of the cylindrical case and a second extremity positioned in the inner chamber.

EX43. The device according to EX42, wherein the first extremity of the central shaft is rotatably supported by the supporting structure.

EX44. The device according to EX42 or EX43 when EX34 is according to EX5, wherein the second extremity of the central shaft is pivotally coupled to the second end of the shaft so that the central shaft and the shaft may rotate in the opposite directions.

EX45. The device according to EX44, wherein the second extremity of the central shaft is supported by the frame, optionally through radial struts.

EX46. The device according to any of EX1 to EX45, wherein the first end of the shaft is rotatably supported by the supporting structure and/or by a sleeve connected to the cylindrical case through radial struts.

EX47. The device according to any of EX1 to EX46, comprising at least one conveyor located under the cylindrical case to receive lamina separated from stems and passed through the at least one mesh wall or the plurality of mesh walls.

EX48. The device according to EX47, wherein the at least one conveyor extends along a conveying direction parallel to the longitudinal axis of the cylindrical case or transversally to the longitudinal axis of the cylindrical case.

EX49. The device according to EX47 or EX48, wherein the at least one conveyor comprises a transport belt and an upper branch of the transport belt faces the cylindrical case.

EX50. The device according to any of EX47 to EX49, wherein the at least one conveyor comprises a plurality of conveyors locates at different locations under the cylindrical case.

EX51. The device according to any of EX47 to EX50, wherein the at least one conveyor comprises at least a first conveyor configured to convey away lamina passing through the mesh wall or mesh walls and falling onto said first conveyor and a second conveyor configured to convey away stems passing through the mesh wall or mesh walls or through a distal aperture on the distal end of the cylindrical case and falling onto said second conveyor.

EX52. The device according to any of EX1 to EX51, comprising a coverage surrounding at least in part the cylindrical case.

EX53. The device according to EX51, wherein the coverage is fixed with respect to the supporting structure.

EX54. The device according to any of EX1 to EX53, comprising rollers rotatably mounted on the supporting structure, the cylindrical case being supported on said rollers.

EX55. The device according to EX54, wherein the cylindrical case comprises annular tracks coaxial to the longitudinal axis and engaging a peripheral surface of the rollers.

EX56. The device according to EX55 when EX54 is according to any of EX34 to EX45, wherein the annular tracks are part of the frame or of the walls.

EX57. The device according to any of EX1 to EX56, wherein the at least one motor comprises a first motor operatively coupled to the cylindrical case and a second motor operatively coupled to the shaft.

EX58. The device according to any of EX1 to EX57, wherein the at least one motor is mounted on the supporting structure.

EX59. The device according to any of EX1 to EX58, comprising a cap mounted on the supporting structure and fixed with respect to the supporting structure, the cap closing the proximal end of the cylindrical case, the inlet opening being fashioned in the cap.

EX60. The device according to any of EX1 to EX59, wherein the cylindrical case is mounted on the supporting structure such that the longitudinal axis is inclined downwards from the proximal end towards the distal end of the cylindrical case of an inclination angle; optionally said inclination angle is adjustable.

EX 61. The device according to EX 60, wherein the inclination angle is between 0° and 10°.

EX62. A method for de-stemming tobacco leaves through the device according to one or more of EX1 to EX61.

EX63. The method of EX62, comprising:
introducing tobacco leaves in the cylindrical case through the inlet opening;
activating the at least one motor to rotate the cylindrical case and the shaft in opposite directions so that lamina of the tobacco leaves are separated from stems of said tobacco leaves, the lamina and stems being sieved through the mesh wall or mesh walls.

EX64. The method of EX62 or EX63, comprising:
introducing a mass of tobacco leaves in the inner chamber of the cylindrical case;
disaggregating the mass of tobacco leaves through the plurality of elements protruding inside the inner chamber from the cylindrical case and the plurality of shaft elements developing from the only one shaft located inside the cylindrical case and by rotating the cylindrical case and said shaft in opposite directions;
separating stems from lamina of the tobacco leaves through shuffling the tobacco leaves in the inner chamber by raising the tobacco leaves on walls of the cylindrical case and making the tobacco leaves fall, raising being performed through the rotation of the cylindrical case;
sieving parts of lamina of the tobacco leaves and/or stems through the at least one mesh wall of the cylindrical case.

EX65. The method according to EX63 or EX64, wherein the lamina pass through the mesh wall or mesh walls and the stems are moved towards the distal end of the cylindrical case, optionally the stems exit through a distal aperture on the distal end of the cylindrical case.

EX66. The method according to any of EX63 to EX65, wherein lamina passing through the mesh wall or mesh walls fall onto at least one first conveyor and are conveyed away.

EX67. The method according to any of EX63 to EX66, wherein stems fall onto a second conveyor and are conveyed away.

EX68. The method according to EX67, wherein the second conveyor is placed downstream of the at least one first conveyor with respect to a movement of the along the cylindrical case.

EX69. The method according to any of EX63 to EX68, wherein the tobacco leaves, when introduced in the cylindrical case, are dry.

EX70. The method according to any of EX63 to EX69, wherein a moisture content of the tobacco leaves, when introduced in the cylindrical case, is between 5% and 25%, optionally below 15%, optionally below 15%.

EX71. A tobacco production line and comprising a device for de-stemming tobacco leaves according to any of EX1 to EX61 and/or employing a method for de-stemming tobacco leaves according to any of EX63 to EX70.

EX72. The tobacco production line of EX71, comprising an infeed line connected to the inlet opening of the device for de-stemming tobacco leaves.

EX73. The tobacco production line of EX71 or EX72, comprising a pneumatic separator and/or a sieve and/or a drier and/or a packing line connected in line downstream of the device for de-stemming tobacco leaves.

Examples will now be further described with reference to the figures in which:

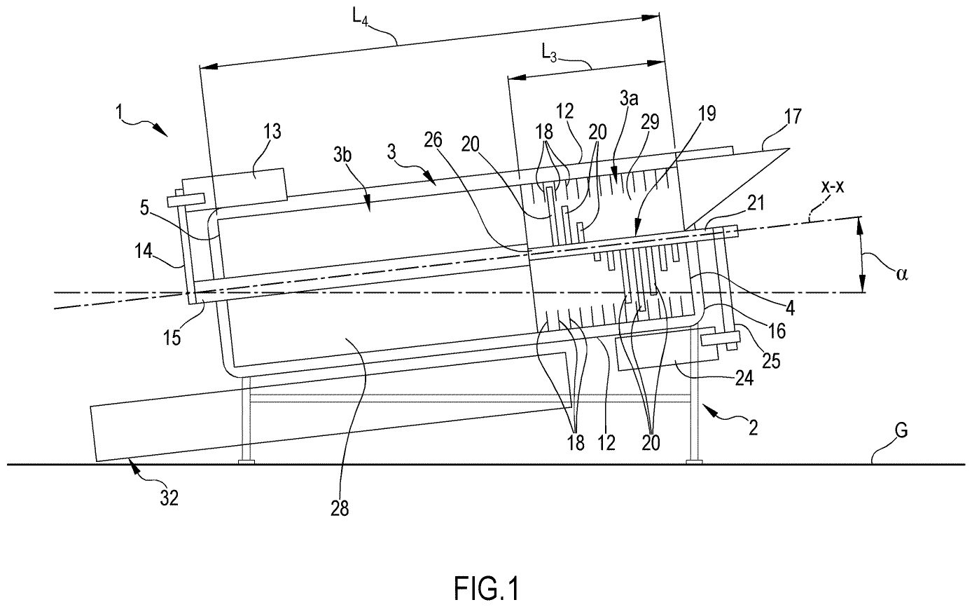

FIG. 1 shows a side schematic view of a device for de-stemming tobacco leaves according to the invention;

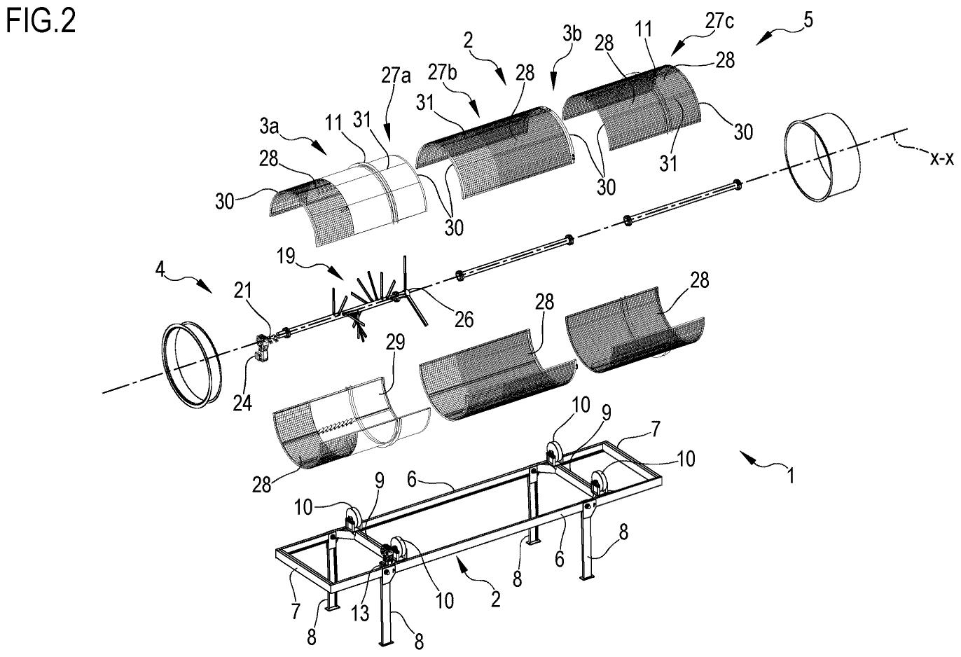

FIG. 2 is an exploded view of the device of FIG. 1;

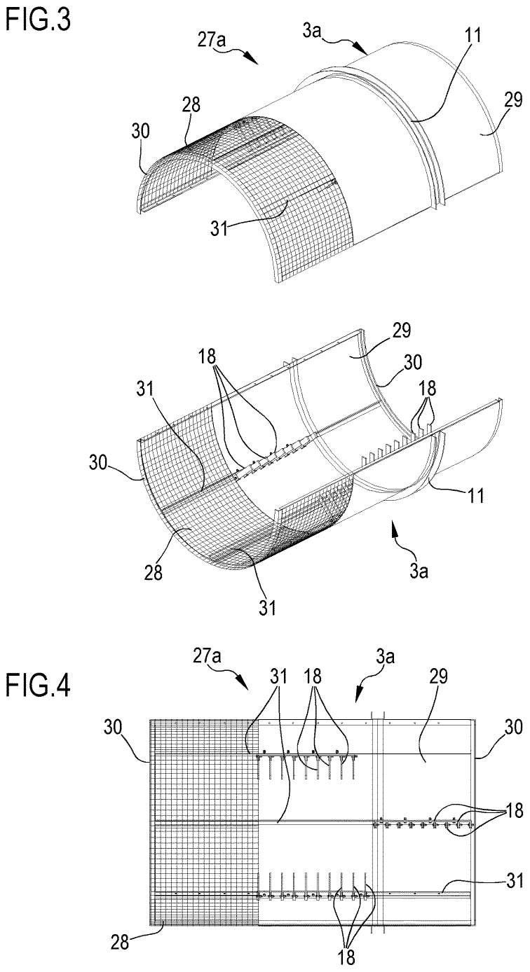

FIG. 3 is a 3D of two elements of the device of FIGS. 1 and 2;

FIG. 4 is a side view of one of the elements of FIG. 3;

FIG. 5 is a 3D of another element of the device of FIGS. 1 and 2;

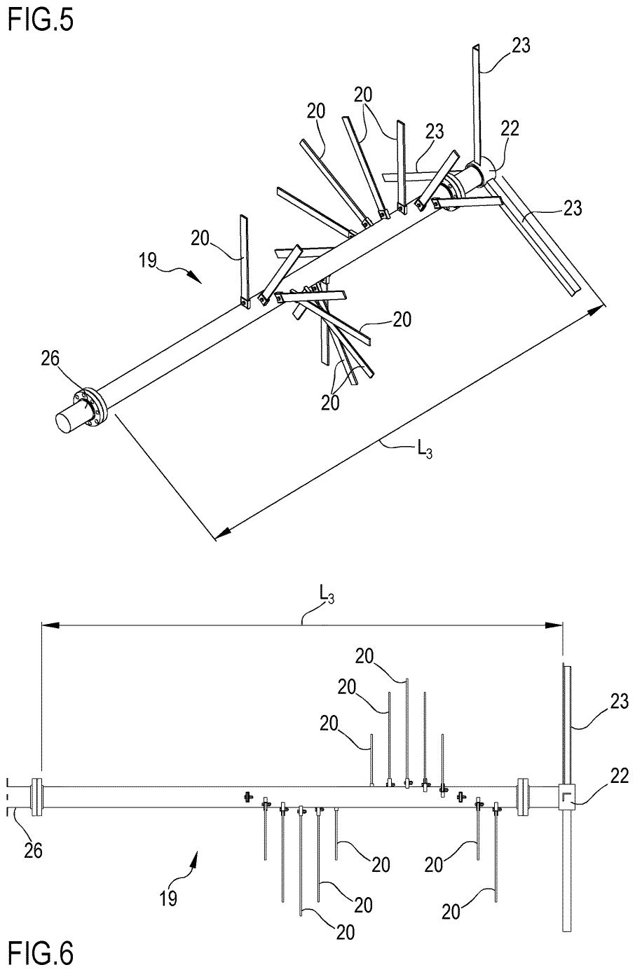

FIG. 6 is a side view of the element of FIG. 5;

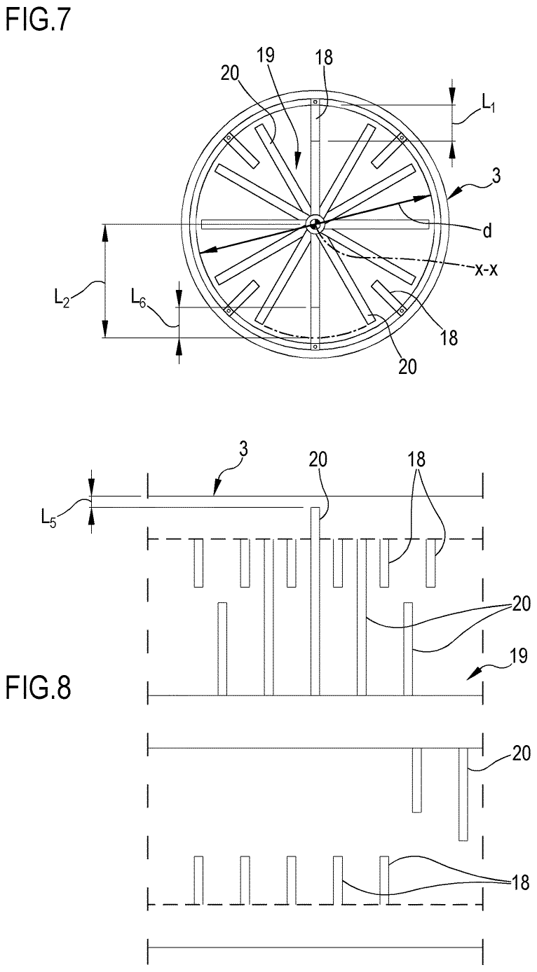

FIG. 7 is a cross section according to plane I-I of FIG. 1;

FIG. 8 is an enlarged view of a portion of the device of FIGS. 1 and 2;

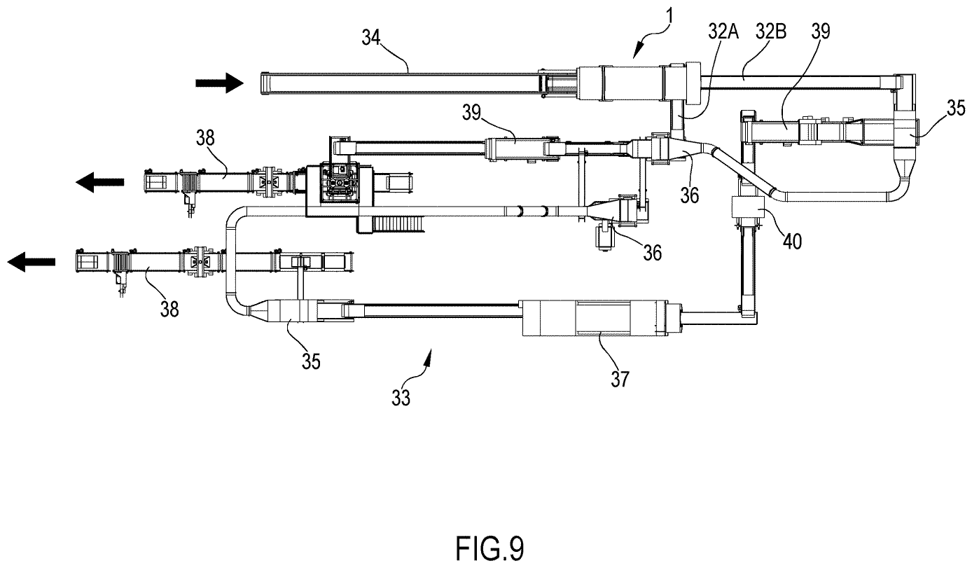

FIG. 9 is a plan view of a tobacco production line comprising the device of the preceding Figures.

The device 1 shown in FIGS. 1 to 9 is a device for de-stemming tobacco leaves. The device 1 comprises a supporting structure 2 configured to rest on a base or on ground “G” and a cylindrical case 3 mounted on the supporting structure 2 and delimiting an inner chamber. The cylindrical case 3 has a longitudinal axis “X-X”, a proximal end 4 and a distal end 5 opposite the proximal end 4. The cylindrical case 3 is elongated. A ratio of an inner diameter “d” of the cylindrical case 3 to an overall axial length “L4” of the cylindrical case 3 may be between ⅓ to ⅔, optionally between ⅓ to ½.

The cylindrical case 3 is mounted on the supporting structure 2 such that said cylindrical case 3 is able to rotate about the longitudinal axis “X-X” with respect to the supporting structure 2.

In the example embodiment shown in the attached FIG. 2, the supporting structure 2 comprises a peripheral frame having two longitudinal beams 6 and two transverse beams 7 and supported by four legs 8. Two additional transversal beams 9 connect the two longitudinal beams 6 and carry each a pair of rollers 10 facing upwards. The four rollers 10 are rotatably mounted on the additional transversal beams 9 and the cylindrical case 3 is supported on said rollers 10. The cylindrical case 3 comprises two annular tracks 11 (FIGS. 2 and 3) coaxial to the longitudinal axis “X-X” and engaging a peripheral surface of the rollers 10. A coverage 12, schematically depicted only in FIG. 1, is fixed with respect to the supporting structure 2 and surrounds the cylindrical case 3. The rollers 10 are installed on the additional transversal beams 9 such that the cylindrical case 3 may be inclined relative to a horizontal plane, i.e. to the ground “G”, downwards from the proximal end 4 towards the distal end 5 of the cylindrical case 3 of an inclination angle “α”. The inclination angle may be adjustable, for instance between 0° and 10°.

A first motor 13 is operatively coupled to the cylindrical case 3 and is configured to rotate the cylindrical case 3 about the longitudinal axis “X-X” and with respect to the supporting structure 2. In the schematic FIG. 1, the first motor 13 is mounted on the coverage 12 and connected through a belt 14 to a first extremity 15a of a central shaft 15 integral with or fixed to the cylindrical case 3. In the embodiment of FIG. 2, the first motor 13 is mounted on the supporting structure 2 and connected to one of the rollers 13 to rotate said roller 13 and, through the roller 13, the cylindrical case 3. The cylindrical case 3 rotates about the longitudinal axis “X-X” while rolling on the rollers 13.

The device 1 comprises a cap 16 mounted on the supporting structure 2 and fixed with respect to the supporting structure 2. The cap 16 closes the proximal end 4 of the cylindrical case 3. An inlet opening 17 is fashioned in the cap 16 and is configured to enter the tobacco leaves in the proximal end 4 of the cylindrical case 3. In schematic FIG. 2, the cap 16 is represented as part of the covering 12 and the inlet opening 17 is delimited by a chute or hopper mounted on the cap 16.

The cylindrical case 3 of schematic FIG. 1 comprises a first part 3a close to the proximal end 4 and made of a solid wall (i.e. wall with no through passages) and a second part 3b made of a mesh wall (i.e. wall with a plurality of through passages). The first part 3a and second part 3b are positioned one after the other along the longitudinal axis “X-X”. In other embodiments, not shown, the first part 3a comprises a solid cover preventing tobacco leaves from passing through.

The first part 3a comprises a plurality of series of elements 18 protruding radially from the solid wall towards the longitudinal axis “X-X”. Each series comprises a plurality of elements 18 aligned along a line parallel to the longitudinal axis “X-X”. Different series are disposed circumferentially equally spaced from each other. FIG. 1 shows the cylindrical case 3 standing still and a top series disposed angularly offset of 180° with respect a bottom series. Each element 18 is a straight rod and is fixed to the cylindrical case 3 and stationary with respect to the cylindrical case 3 to rotate together with the cylindrical case 3. The rods may be flat or may have a circular cross section.

Each series of FIG. 1 extends all along the first part 3a. Each series of FIGS. 3 and 4 extends half of a length of the first part 3a and the elements 18 of one of the series are axially offset with respect to the elements 18 of an adjacent series. The series are circumferentially equally spaced from each other, as represented in FIGS. 3, 4 and 7.

A length “L1” of the elements 18 is such that they protrude partially inside the inner chamber. For instance, a ratio of the length “L1” of the elements 18 to the inner radius “d/2” of the cylindrical case 3 is between ⅛ and ¼, optionally of ⅓.

Only one shaft 19 is located inside the first part 3a. A main axis of the shaft 19 matches with the longitudinal axis “X-X” of the cylindrical case 3 and the only one shaft 19 is coaxial to the cylindrical case 3. In other embodiments, not shown in drawings, the main axis of the shaft 19 and the longitudinal axis “X-X” of the cylindrical case 3 may be parallel and close to each other. In FIG. 1, the first part 3a of the cylindrical case 3 close to the proximal have an axial length equal or close to an axial length “L3” of the shaft 19.

A plurality of shaft elements 20 develop radially from the shaft 19. Each shaft element 20 is fixed to the shaft 19.

The shaft 19 of FIG. 1 is better represented in FIGS. 5, 6, 7 and 8. The shaft elements 20 are flat straight rods, are axially offset one relative to the other along the shaft 19, such that each axial portion of the shaft 19 comprises a single shaft element 20, and are placed according to a helical path all along said shaft 19 or along part of the shaft 19.

A length “L2” of the shaft elements 20 is such that terminal free ends of the shaft elements 20 are close to the cylindrical case 3. For instance, a ratio of the length “L2” of the shaft elements 20 to the inner radius “d/2” of the cylindrical case 3 may be between 0.8 and 0.99, optionally of 0.9 and a gap “L5” between the terminal free ends of the shaft elements 20 and the cylindrical case 3 may be between 10 mm and 450 mm. Each shaft element 20 is axially positioned between two adjacent elements 18 of the cylindrical case 3.

The shaft 19 is rotatable about the respective main axis with respect to the cylindrical case 3 and with respect to the supporting structure 2.

The shaft 19 protrudes from the proximal end 4 of the cylindrical case 3 and a first end 21 of the shaft 19 is pivotally supported by the supporting structure 2. In FIG. 1, the first end 21 of the shaft 19 is pivotally supported by the covering 12. The shaft 19 is also pivotally supported by a bushing 22 coupled to the cylindrical case 3 through radial struts 23. The shaft extends 19 only partially along the cylindrical case 3 starting from the proximal end 4. A ratio of an axial length “L3” of the shaft 19, i.e. of the part of the shaft located inside the inner chamber, to the overall axial length “L4” of the cylindrical case 3 is between ¼ and ½, optionally of ⅓.

A second motor 24 is operatively coupled to the shaft 20 to rotate the shaft 20 about the respective main axis and in opposite directions with respect to the cylindrical case 3. For instance, the cylindrical case 3 is rotated clockwise and the shaft 20 is rotated counter-clockwise or the cylindrical case 3 is rotated counter-clockwise and the shaft 20 is rotated clockwise. In FIG. 1, the second motor 24 is mounted on the supporting structure 2 and is connected through a belt 25 to the first end 21 of the shaft 19. In FIG. 1, a second end 26 of the shaft 19 is pivotally coupled to and supported by a second extremity 15b of the central shaft 15 and the second extremity 15b of the central shaft 15 may supported in the cylindrical case 3 through radial struts, not shown. In FIG. 2, the second motor 24 is coupled to the first end 21 of the shaft 19. A first extremity of the central shaft is located at the distal end 5 of the cylindrical case 3.

In the example embodiment of FIGS. 2, 3 and 4, the cylindrical case 3 is made by a plurality of cylindrical portions 27a, 27b, 27c positioned one after the other along the longitudinal axis “X-X”. Each cylindrical portions 27a, 27b, 27c is made of two semi-cylindrical portions, each comprising a frame and mesh walls 28 and/or solid walls 29 mounted on the frame. The frame comprises arched elements 30 and longitudinal elements 31.

The mesh walls 28 and/or solid walls 29 have an arched shape. The mesh walls 28 of FIGS. 3 and 4 resemble a net, such that apertures of the mesh are square. The apertures have a size of the side ranging between 10 mm and 60 mm. In other embodiments, not shown, the device may comprise different mesh walls having different features, like different structures, different shapes and/or sizes of the apertures of the mesh, different void to solid ratios.

A first cylindrical portion 27a is represented in FIGS. 3 and 4 and comprises the first part 3a provided with the solid wall 29 and a mesh wall 28. One annular tracks 11 is located on the solid wall 29 (FIGS. 2 and 3). A second cylindrical portion 27b and a third cylindrical portion 27c are represented in FIG. 2. The second cylindrical portion 27b comprises the frame and a mesh wall 28. The third cylindrical portion 27c comprises the frame, a mesh wall 28 and another annular tracks 11.

Thus the overall cylindrical case 3 comprises a frame and a plurality of walls 28, 29 mounted on the frame and delimiting the inner chamber. The frame comprises annular elements, each made of two arched elements 30 and coaxial to the longitudinal axis “X-X”, and longitudinal elements 31 connecting the annular elements to each other. The walls 28, 29 are mounted on the frame so that said walls 28, 29 can be removed from the frame and replaced to easily adapt the device to properties and/or volume of the tobacco leaves to be processed. Also the inclination angle “a” may be adjusted for product residence time inside the cylindrical case 3 and also may vary in function of load and tobacco characteristics.

The device 1 further comprises one conveyor 32A, 32B located under the cylindrical case 3 to receive lamina separated from stems and passed through the mesh walls 28. FIG. 1 shows schematically one conveyor 32A, 32B. The conveyor 32A, 32B may comprise a transport belt and an upper branch of the transport belt faces the cylindrical case 3.

FIG. 9 shows a tobacco production line 33 comprising a device 1 for de-stemming tobacco leaves. The tobacco production line 33 comprises a feeding conveyor 34 placed upstream of the device 1 and terminating at the inlet opening 17 of the cylindrical case 3. The feeding conveyor 34 is configured to feed the tobacco leaves to the proximal end 4 of the cylindrical case 3. A first conveyor 32A and a second conveyor 32B are located in part under the device 1. The first conveyor 32A extends transversally to the longitudinal axis “X-X” of the cylindrical case 3 and is configured to convey away lamina passing through the mesh walls 28 and falling onto said first conveyor 32A. The second conveyor 32B extends along a conveying direction parallel to the longitudinal axis “X-X” of the cylindrical case 3 and is configured to convey away stems passing through the mesh walls 28 or through a distal aperture on the distal end 5 of the cylindrical case 3 and falling onto said second conveyor 32B.

Downstream of the device 1 for de-stemming tobacco leaves, the tobacco production line 33 may comprise one or more pneumatic separators 35, sieves 36, driers 37, packing lines 38, weight belts 39, laminators 40, known per se and not detailed.

In use and according to a method for de-stemming tobacco leaves, a mass of tobacco leaves are introduced in the cylindrical case 3 through the inlet opening by the feeding conveyor 34. A moisture content of the tobacco leaves, when introduced in the cylindrical case 3 is below 15% and may be below 10%.

The first motor 13 and the second motor 24 are activated to rotate the cylindrical case 3 and the shaft 19 in opposite directions. In the first part 3a of the cylindrical case 3, the mass of tobacco leaves is disaggregated through the plurality of elements 18 protruding inside the inner chamber from the cylindrical case 3 and the plurality of shaft elements 20 developing from the only one shaft 19 located inside the cylindrical case 3 while the cylindrical case 3 and said shaft 19 rotate in opposite directions.

When the cylindrical case 3 and the shaft 19 rotate in opposite directions, terminal free ends of the shaft elements 20 travel between terminal free ends of adjacent elements 18 and the terminal free ends of the shaft elements 20 and terminal free ends of the elements 18 overlap for a radial distance “L6”. The terminal free ends of the shaft elements 20 are axially spaced from terminal free ends of adjacent elements 18 of a distance for instance of 150 mm. A ratio of the radial distance “L6” to an inner radius “d/2” of the cylindrical case is between 0.05 and 0.2, optionally of 0.1.

The tobacco leaves in the inner chamber is shuffled by raising the tobacco leaves on walls of the cylindrical case 3 through the rotation of the cylindrical case 3 and making the tobacco leaves fall. Thus, the stems are separated from lamina.

The lamina pass through the mesh walls 28 and the stems are moved towards the distal end 5 of the cylindrical case 3 and exit through a distal aperture on a distal end 5 of the cylindrical case 3. Lamina passing through the mesh walls 28 fall onto the first conveyor 32A and are conveyed away. The stems fall onto the second conveyor 32B and are conveyed away.

In other embodiments, a void to solid ratio of the mesh wall 28 of the second part 3b decreases moving from the proximal end 4 towards the distal end 5 of the cylindrical case 3 and a plurality of conveyors are located at different locations under the cylindrical case 3. This way, lamina are sieved, separated and conveyed away according to the size of the broken particles: larger particles upstream and smaller particles downstream.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-22. (canceled)

23. A device for de-stemming tobacco leaves, comprising:
a supporting structure configured to rest on a base or on ground;
a cylindrical case having a longitudinal axis, a proximal end and a distal end opposite the proximal end; the cylindrical case delimiting an inner chamber; the cylindrical case being mounted on the supporting structure to rotate about the longitudinal axis; the longitudinal axis being horizontal or being inclined with respect to the ground; the cylindrical case comprising at least one mesh wall, optionally a plurality of mesh walls; the cylindrical case comprising a plurality of elements protruding inside the inner chamber;
only one shaft located inside the cylindrical case and comprising a plurality of shaft elements developing from said shaft, the shaft being rotatable about a respective main axis and with respect to the cylindrical case;
at least one motor operatively coupled to the cylindrical case and to the shaft, the at least one motor being configured to rotate the cylindrical case and the shaft in opposite directions, in order to separate lamina from stems of the tobacco leaves by making the leaves tumbling inside the cylindrical case;
the supporting structure having an inlet opening configured to enter tobacco leaves, wherein the inlet opening is located at the proximal end of the cylindrical case.

24. The device of claim 23, wherein the main axis of the shaft and the longitudinal axis of the cylindrical case overlap.

25. The device of claim 23, wherein the shaft extends only in a first part of the cylindrical case close to the proximal end.

26. The device of claim 23, wherein a ratio of an axial length of the shaft to an overall axial length of the cylindrical case is between ¼ and ½.

27. The device of claim 23, wherein the cylindrical case comprises a first part close to the proximal end and the plurality of elements is located only in said first part of the cylindrical case; wherein said first part of the cylindrical case close to the proximal end has an axial length equal or close to an axial length of the shaft; wherein said first part of the cylindrical case close to the proximal end is made at least partially of a solid wall or comprises a solid cover preventing tobacco leaves from passing through; wherein a remaining second part of the cylindrical case, extending from the first part to the distal end, is made of the at least one mesh wall or comprises the at least one mesh wall.

28. The device of claim 23, wherein a void to solid ratio of the at least one mesh wall decreases moving from the proximal end towards the distal end of the cylindrical case.

29. The device of claim 23, wherein the cylindrical case is elongated, optionally wherein a ratio of an inner diameter of the cylindrical case to an overall axial length of the cylindrical case is between ⅓ and ⅔.

30. The device of claim 23, wherein the elements are placed in a plurality of series along lines parallel to the longitudinal axis of the cylindrical case; wherein the elements of one of the series is axially offset with respect to the elements of an adjacent series.

31. The device of claim 23, wherein terminal free ends of the shaft elements (20) are close to the cylindrical case; wherein a ratio of a length of the shaft elements to an inner radius of the cylindrical case is between 0.8 and 0.99.

32. The device of claim 23, wherein each axial portion of the shaft comprises a single shaft element; wherein optionally the shaft elements are placed according to a helical path along the shaft ; wherein terminal free ends of the shaft elements are axially spaced from terminal free ends of adjacent elements of a distance greater than 150 mm.

33. The device of claim 23, wherein, when the cylindrical case and the shaft rotate in opposite directions, terminal free ends of the shaft elements and terminal free ends of the elements overlaps for a radial distance and a ratio of said radial distance to an inner radius of the cylindrical case is between 0.05 and 0.2.

34. The device of claim 23, wherein the cylindrical case comprises a frame and a plurality of walls mounted on the frame and delimiting the inner chamber; wherein the walls are mounted on the frame so that said walls can be removed from the frame and replaced.

35. The device of claim 23, comprising at least one conveyor located under the cylindrical case to receive lamina separated from stems and passed through the at least one mesh wall or the plurality of mesh walls; wherein the at least one conveyor comprises at least a first conveyor configured to convey away lamina passing through the mesh wall or mesh walls and falling onto said first conveyor and a second conveyor configured to convey away stems passing through the mesh wall or mesh walls or through a distal aperture on the distal end of the cylindrical case and falling onto said second conveyor.

36. A method for de-stemming tobacco leaves through the device of claim 23, wherein the method comprises:
introducing a mass of tobacco leaves in the inner chamber of the cylindrical case;
disaggregating the mass of tobacco leaves through the plurality of elements protruding inside the inner chamber from the cylindrical case and the plurality of shaft elements developing from the only one shaft located inside the cylindrical case and by rotating the cylindrical case and said shaft in opposite directions;
separating stems from lamina of the tobacco leaves through shuffling the tobacco leaves in the inner chamber by raising the tobacco leaves on walls of the cylindrical case and making the tobacco leaves fall, raising being performed through the rotation of the cylindrical case;
sieving parts of lamina of the tobacco leaves and/or stems through the at least one mesh wall of the cylindrical case.

37. The method of claim 36, wherein the lamina pass through the mesh wall or mesh walls and the stems are moved towards the distal end of the cylindrical case, optionally the stems exit through a distal aperture on the distal end of the cylindrical case; wherein lamina passing through the mesh wall or mesh walls fall onto at least one first conveyor and are conveyed away and the stems fall onto a second conveyor and are conveyed away.

38. The device of claim 23, wherein a ratio of an axial length of the shaft to an overall axial length of the cylindrical case is ⅓.
